(19) United States
(12) Patent Application Publication
(10) Pub. No.: US 2021/0114038 A1
(43) Pub. Date: Apr. 22, 2021

(54) PLANT PREPARATION AND PROCESSING SYSTEM

(71) Applicants: BLAKE SANDNES, SIOUX FALLS, SD (US); ROY OLSON, SIOUX FALLS, SD (US); JOSHUA TRACY, HARRISBURG, SD (US); ALEX PEARSON, SIOUX FALLS, SD (US)

(72) Inventors: BLAKE SANDNES, SIOUX FALLS, SD (US); ROY OLSON, SIOUX FALLS, SD (US); JOSHUA TRACY, HARRISBURG, SD (US); ALEX PEARSON, SIOUX FALLS, SD (US)

(21) Appl. No.: 17/068,025

(22) Filed: Oct. 12, 2020

Related U.S. Application Data
(60) Provisional application No. 62/915,827, filed on Oct. 16, 2019.

(51) Int. Cl. B02C 11/08; B02C 23/30; B02C 21/02; B02C 25/00

(52) U.S. Cl. CPC B02C 11/08; B02C 25/00; B02C 21/02; B02C 23/30

(57) ABSTRACT

A plant processing system may include an initial preparation apparatus for treating plant material prior to processing the plant material, and the initial preparation apparatus may be configured to lower a temperature of the plant material from an initial temperature to a lowered temperature. The system may also include a plant processing apparatus configured to process the plant material received from the initial preparation apparatus at approximately the lowered temperature. In some embodiments, the plant processing apparatus may be a plant stripping apparatus configured to detach constituent parts of the plant material from each other. In some embodiments, the plant processing apparatus may be a plant grinding apparatus configured to grind constituent parts of the plant material.

### REFERENCE TO RELATED APPLICATION

This application claims the benefit of the priority of U.S. Provisional Patent Application No. 62/915,827, filed Oct. 16, 2019, which is hereby incorporated by reference in its entirety.

### BACKGROUND

### Field

The present disclosure relates to plant processing machinery and more particularly pertains to a new plant preparation and processing system for processing plant material with less potential damage to constituent elements of the plant material.

### SUMMARY

The present disclosure relates to a plant processing system which may include an initial preparation apparatus for treating plant material prior to processing the plant material, and the initial preparation apparatus may be configured to lower a temperature of the plant material from an initial temperature to a lowered temperature. The system may also include a plant processing apparatus configured to process the plant material received from the initial preparation apparatus at approximately the lowered temperature. In some embodiments, the plant processing apparatus may be a plant stripping apparatus configured to detach constituent parts of the plant material from each other. In some embodiments, the plant processing apparatus may be a plant grinding apparatus configured to grind constituent parts of the plant material.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components, and the particulars of the steps, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic block diagram of a new plant preparation and processing system according to the present disclosure.

FIG. 2A is a schematic flow diagram of a method of preparing and processing plant materials, according to an illustrative implementation.

FIG. 2B is a schematic flow diagram of another method of preparing and processing plant materials, according to an illustrative implementation.

FIG. 3 is a schematic block diagram of the gas supply apparatus of the system, according to an illustrative embodiment.

FIG. 4 is a schematic perspective view of elements of the plant preparation and processing system, according to an illustrative embodiment.

FIG. 5 is a schematic perspective view of a portion of the system including an initial preparation apparatus, according to an illustrative embodiment.

FIG. 6 is a schematic side sectional view of the stripping apparatus of the system, according to an illustrative embodiment.

FIG. 7 is a schematic perspective view of the separating apparatus with portions removed to reveal details, according to an illustrative embodiment.

FIG. 8 is a schematic side view of a system including a preparation apparatus and a grinding apparatus, according to an illustrative embodiment.

FIG. 9 is a schematic perspective view of a portion of the system shown in FIG. 8, according to an illustrative embodiment.

FIG. 10 is a schematic perspective sectional view of a portion of the system shown in FIG. 8, according to an illustrative embodiment.

FIG. 11 is a schematic side sectional view of the portion of the system shown in FIG. 10, according to an illustrative embodiment.

### DETAILED DESCRIPTION

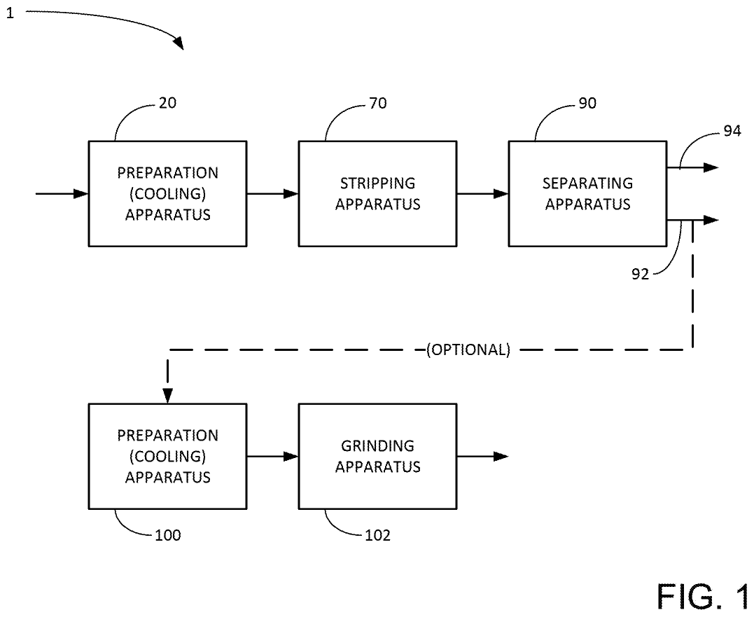

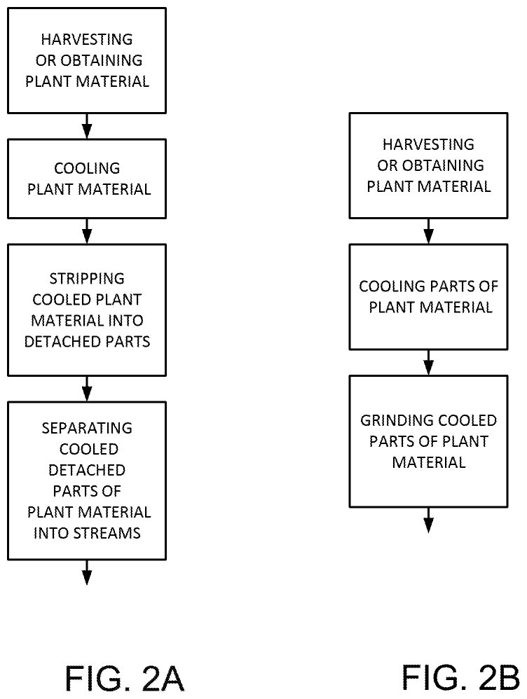

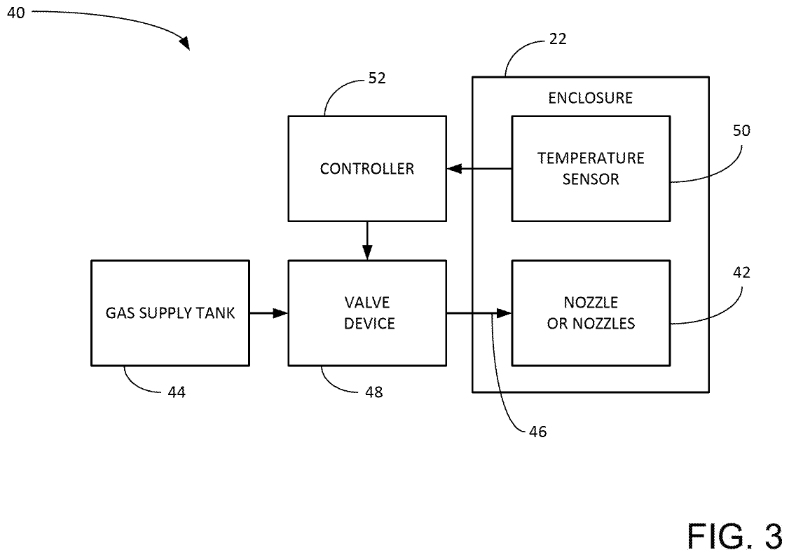

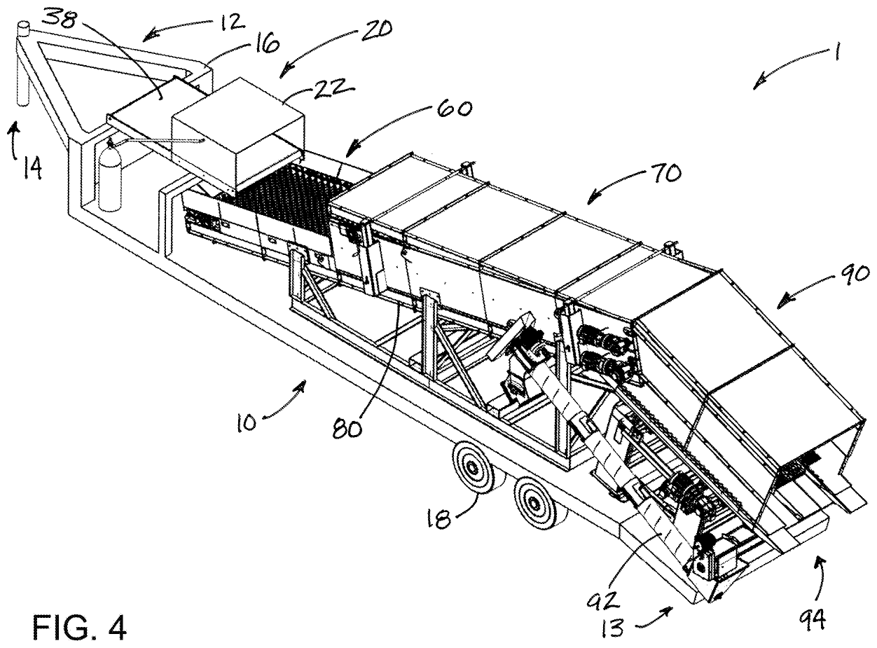

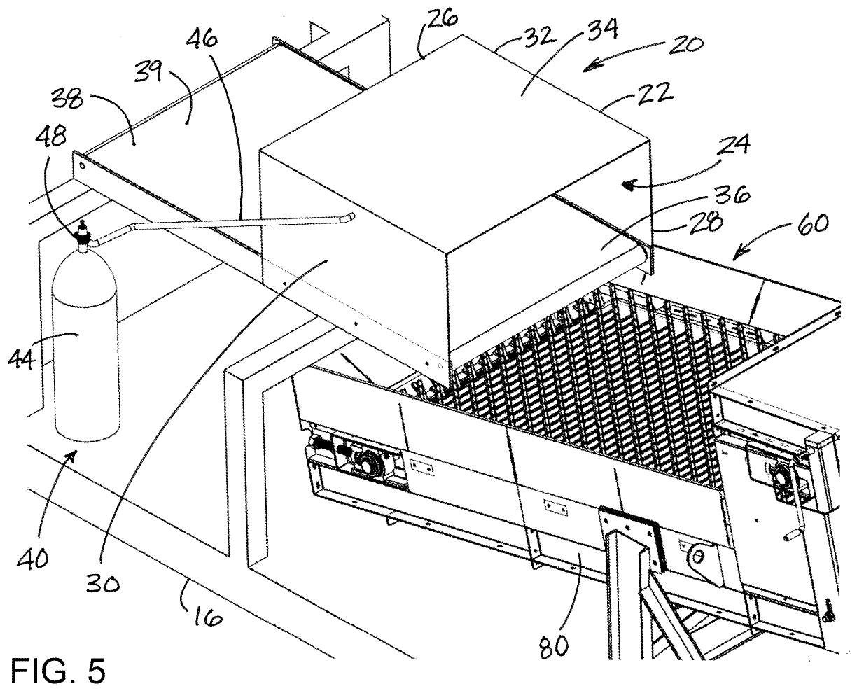

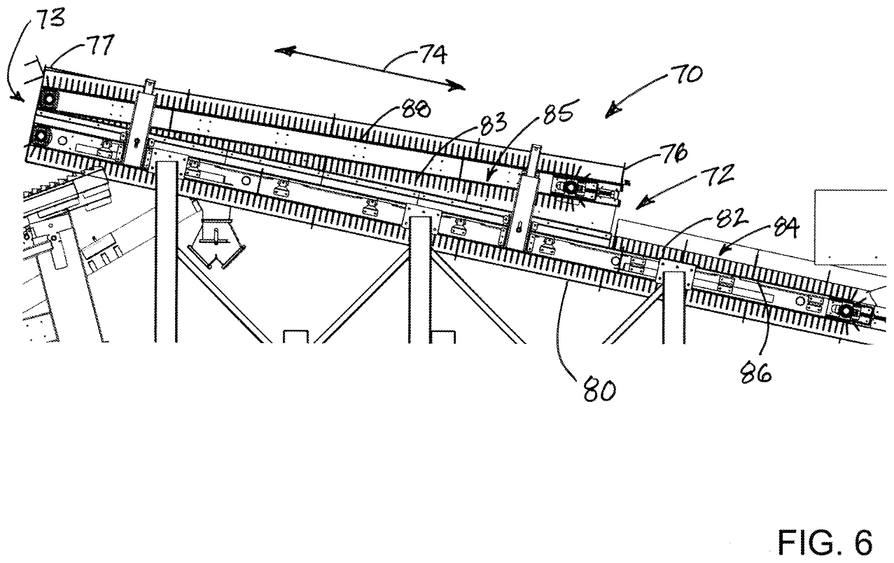

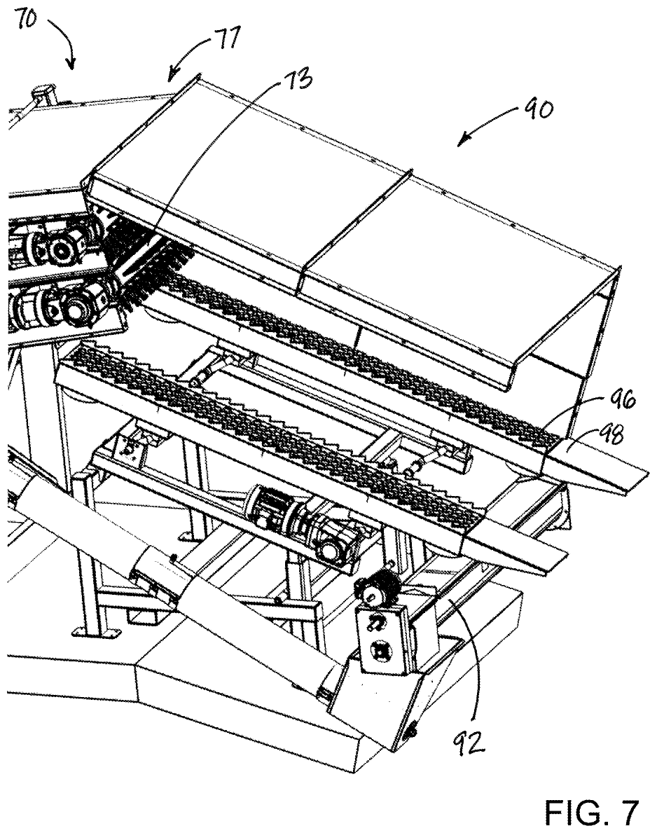

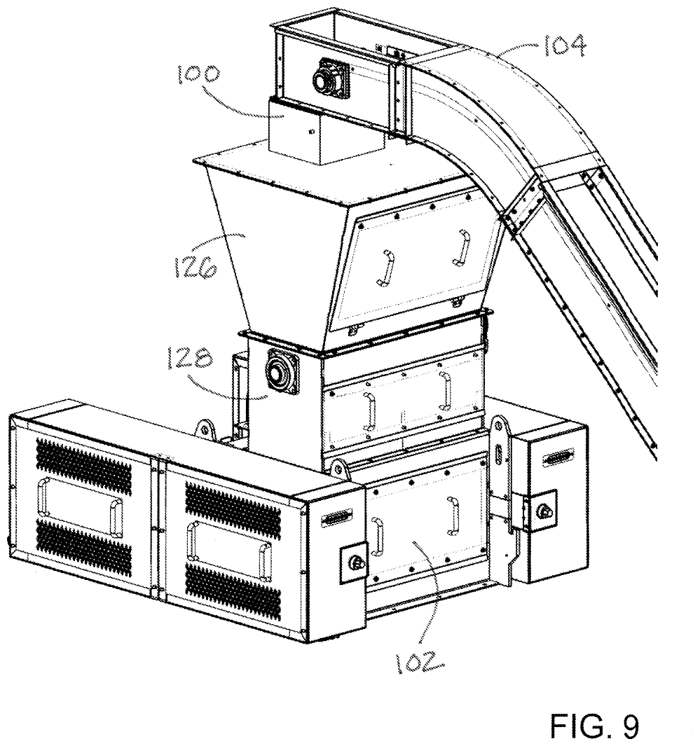

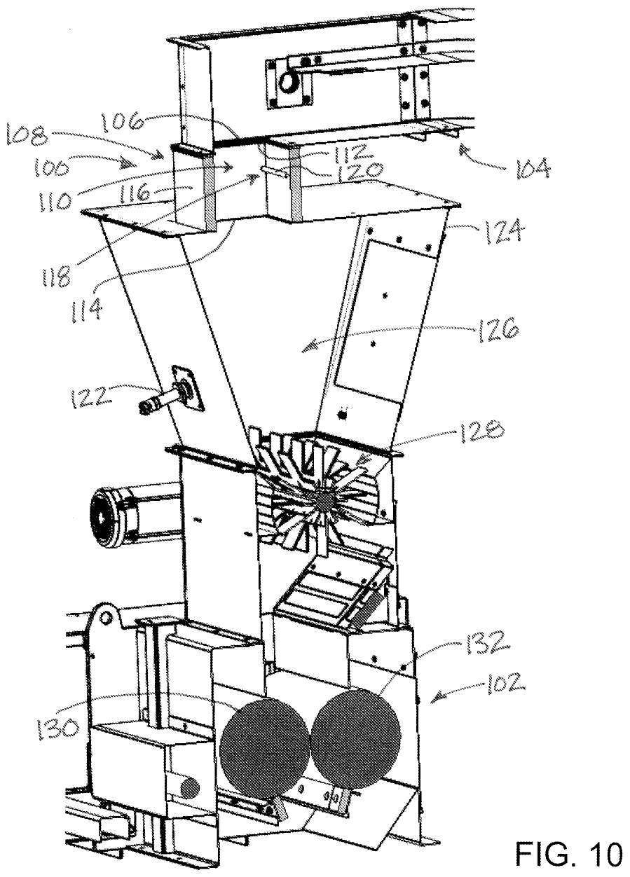

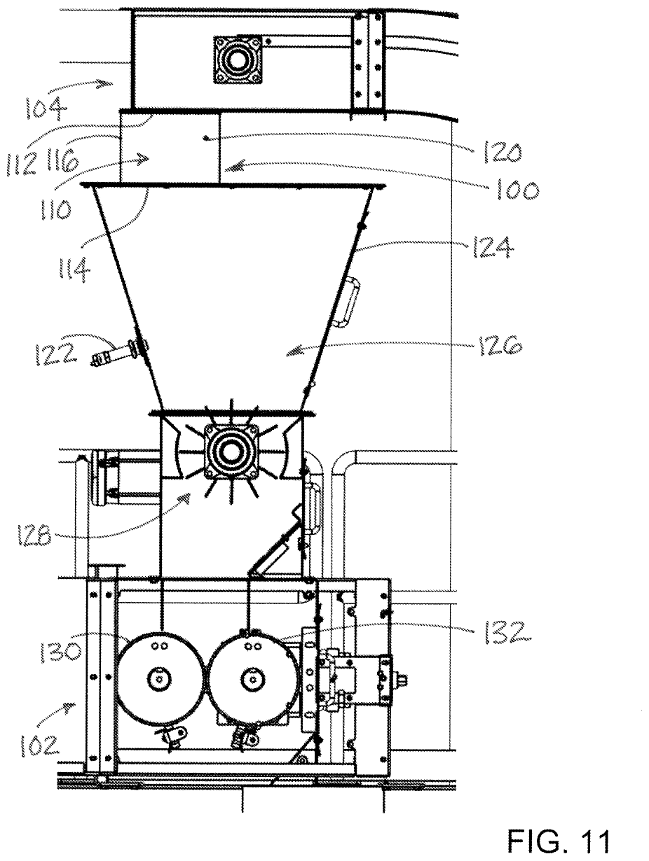

With reference now to the drawings, and in particular to FIGS. 1 through 11 thereof, a new plant preparation and processing system embodying the principles and concepts of the disclosed subject matter will be described.

The processing of crop or plant materials often involves a combination of some form of stripping or cutting constituent parts of a plant from each other and also some form of separating or sorting the detached parts. Typically this processing is tailored to the particular characteristics of the plant material and the difficulties encountered because of those characteristics.

For example, the processing of cannabis plant material may include, after severing the plant from the ground, an initial processing stage such as stripping various types of constituent parts from each, such as detaching buds from the stems and stalks. Some highly suitable techniques and apparatus are disclosed in U.S. Pat. No. 10,524,423, issued Jan. 7, 2020, and assigned to the same assignee as the present application, which is hereby incorporated by reference in its entirety. After detachment of the constituent parts from each other, an additional processing stage may include separating and sorting of the parts may be performed based upon factors such as the parts relative value, the type of further processing to be performed on the parts, etc. A further processing stage for some types of constituent parts may include grinding or milling the parts into smaller pieces more suitable for still further processing, such as oil extraction. Some highly suitable techniques and apparatus for grinding plant material are disclosed in U.S. Pat. No. 10,751,722, issued Aug. 25, 2020, which is hereby incorporated by reference in its entirety.

The applicants have recognized that, just as different types of plant materials may require different types of processing stages, the characteristics of different types of plant materials may also cause problems and complicate the processing stages.

As an illustrative example, cannabis plant material generally contains oil, and the oil tends to be “sticky” or viscid which can have negative effects on the processing of the plant materials. Processing of the plant material tends to release the oil from the plant material and the oil may tend to adhere to and coat various elements of the processing apparatus. In general, this may lead to the oil as well as other constituent parts of the plant material adhering to and accumulating on elements of the processing apparatus. In particular, the buildup of the oil released when grinding or milling the plant parts may accumulate on and coat the grinding rolls. This buildup of oil in turn may lead to an increase in the friction between the plant parts being ground and the grinding rolls, and a corresponding buildup of heat in the plant material being ground.

Not only may the resulting rise in temperature affect the operation and longevity of the plant processing apparatus, in the case of cannabis plant material, the heating of the plant parts may cause some degree of decarboxylation of the oils in the plant material. This decarboxylation may degrade the quality of the oil or oils recovered from the plant material, such as, for example, oils containing cannabidiol (CBD). As a result, the processing the plant material may harm the quality of the products sought to be obtained from the plant material.

The applicants recognize that lowering the temperature of the plant material while the plant material is being processed has the capability of minimizing the release of the oils, has the capability of decreasing the “stickiness” or viscosity of the oil that is released from the plant material during processing, and has the capability of reducing the accumulation or buildup of the oil on the parts of the processing apparatus and as a result lower or eliminate the heating of the plant material caused by the processing.

The applicants have developed a system in which the plant material is cooled prior to one or more processing steps or stages for the plant material to achieve advantages from the processing of cooled plant material. The inventive system may include exposing the plant material to a cooled or cooling environment prior to processing action on the material, such as by placing the plant material in an environment in which a cooling gas is present, or into which the gas is introduced, to expose the plant material to the gas. The application of the gas to the plant material may be accomplished by, for example, spraying the gas onto or in the proximity of the plant material. Illustratively, the gas may be nitrogen stored in a compressed or “liquid” form in a tank that is released into the environment in which the plant material is present, such as a chamber of an enclosure.

The applicants have discovered that a suitable degree of cooling of the plant materials may decrease the flowability of the oils and the “stickiness” or viscosity exhibited by the oils. In a further benefit of the cooling of the plant material, water in the plant materials may be frozen which may enhance the susceptibility of the plant materials to fracturing during, for example, stripping and grinding processing of the plant materials.

In one aspect, the disclosure relates to a system for processing plant material that may strip constituent parts of the plant material from other constituent parts, may separate the constituent parts of the plant material, and may grind or otherwise breakdown and reduce the size of the parts. The system may be relocatable or portable or repositionable between locations to facilitate, for example, locating the system relatively close to the location at which the plant material is harvested, such as, for example, an agricultural field of any size. In other embodiments the system may be configured for more stationary operation.

In more mobile embodiments, the system 1 may be configured for towing behind a towing vehicle 2 on roads and highways as well as, in some cases, agricultural fields having a ground surface. The system 1 may include a mobile base 10 which may be configured with features to facilitate movement across the ground surface and towing behind the towing vehicle 2. The mobile base may be elongated with a forward end 12 and a rearward end 13 located opposite of the forward end. The forward end of the mobile base may be configured to attach to the towing vehicle 2, and illustratively a hitch 13 may be formed on the mobile base toward the forward end to attach to complementary structure on the towing vehicle. The mobile base may also include a frame 14 which may extend from the forward end 11 to the rearward end 12, and may have a top 15 oriented upwardly and a bottom 16 oriented downwardly toward the ground surface. The mobile base 10 may also include least a pair of wheels 18 which are rotatably mounted on the frame 14 and may be located toward the rearward end 12 of the mobile base away from the hitch 13.

In general, the processing apparatus of the system 1 may include an initial preparation apparatus 20 for cooling the plant material to prepare it for further processing, such as may be performed by a plant stripping apparatus 70 for detaching constituent parts of plants of the prepared plant material from each other and optionally a separating apparatus 90 for separating the detached parts into at least two streams. In some embodiments, the system 1 may include the initial preparation apparatus 20 for preparing the plant material, and a grinding apparatus 102 for grinding the prepared plant material for further processing. In some implementations, a stream from the separating apparatus 90 may be introduced into a second preparation apparatus 100 for cooling the plant parts of the stream before the material is introduced into the grinding apparatus 102.

In illustrative embodiments, the plant material initial preparation apparatus 20 may be configured to treat the plant material prior to processing the plant material, usually for the purpose of facilitating and making more effective the subsequent plant processing operation. In some embodiments, the initial preparation apparatus 20 may be configured to prepare plant material for processing by, for example, the plant stripping apparatus 70 in which constituent parts of the plant materials are detached from each other. In some embodiments, the initial preparation apparatus 20 may be configured to prepare plant material for further processing by, for example, a plant material grinding apparatus 102. In embodiments utilizing the mobile base 10, the initial preparation apparatus 20 may be mounted on the base 10.

The initial preparation apparatus 20 may include a preprocessing enclosure 22 which may define a preprocessing chamber 24 which is configured to receive the plant material to be treated prior to further processing. The preprocessing enclosure 22 may have an entry opening 26 into which untreated plant material may be received into the chamber 24, and an exit opening 28 from which the treated plant material may leave the chamber. Illustratively, the entry 26 and exit 28 openings may be located on opposite ends or sides of the preprocessing enclosure 22. Suitable closures of the entry and exit openings may be provided that provide some isolation of the chamber 24 from the environment surrounding the enclosure, and may include, for example, flaps of flexible material that hang downwardly from a location above the respective opening and have free lower ends.

The preprocessing enclosure 22 may have walls that enclose and define the chamber 24, and may include pair of side walls 30, 32 with each of the side walls extending generally between the entry 26 and exit 28 openings of the enclosure and may extend generally parallel to the direction of movement of the plant material through the enclosure during treatment. The enclosure 22 may also include a top wall 34 extending above the chamber 24 between the side walls 30, 32 and generally between the entry and exit openings. A bottom wall 36 of the enclosure 22 may extend below the chamber 24 in opposition to the top wall 34, and between the side walls 30, 32 and generally between the entry and exit openings.

The chamber 24 may be sized to hold a suitable quantity of the plant material for being treated prior to processing. In an application where plant materials are being prepared for stripping into detached parts, the chamber 24 may be shaped to receive plant material that may be in a form that closely corresponds to the form of the growing plant as the plant material may be relatively newly harvested from the growing field. In some embodiments, the preprocessing enclosure 22 may include a loading platform 38 which is positioned adjacent to the entry opening the bottom wall 36. The loading platform 38 may have an upper surface 39 located adjacent to the entry opening 26 of the enclosure.

The initial preparation apparatus 20 may also include a gas supply apparatus 40 which is configured to cool or lower the temperature of the contents of the preprocessing chamber 24 of the enclosure 22, such as plant material in the chamber 24. The gas supply apparatus 40 may include at least one nozzle 42 which is at least partially positioned in the chamber 24 of the enclosure 22 to dispense gas into the chamber. In some embodiments, the nozzle 42 may comprise a plurality of nozzles which are positioned in the chamber 24 and connected by a manifold.

The gas supply apparatus 40 may also include a gas supply tank 44 which is in communication with the nozzle or nozzles 42 such that gas (or gas compressed to a liquid) contained in the interior of the tank 44 is able to be dispensed from the nozzle or nozzles into the chamber 24. A conduit 46 may connect the gas supply tank 44 to the nozzle or nozzles. A valve device 48 may be configured to control the flow of gas from the gas supply tank to the nozzle or nozzles, and the valve device may be in communication with the conduit. A temperature sensor 50 may be configured to sense a temperature in the preprocessing chamber 24 or may even be configured to sense the temperature of the plant material within the chamber. The temperature sensor 50 may be configured to generate a temperature signal which is representative of the temperature sensed by the temperature sensor in the chamber. A controller 52 may be in communication with the temperature sensor and the valve device 48 and may be configured to control a condition of the valve device (e.g., opened, closed, or some degree of openness in between) based upon the temperature represented by the signal from the sensor 50 and a desired temperature setting for the temperature in the preprocessing chamber.

The plant material may have an initial temperature at which the plant material enters the preprocessing enclosure 22, and the initial temperature may be the ambient temperature of the environment of the system. The plant material may also have a lowered temperature at which the plant material exits the preprocessing enclosure after being exposed to conditions within the preprocessing chamber 24, such as the introduction of the cooling gas into the chamber. The lowered temperature is the approximate temperature of the plant material at which further processing of the plant material occurs, such as, for example, stripping of the plant material or grinding of the plant material.

In some embodiments, the lowered temperature of the plant material is a temperature at or below which the viscosity in the oils in the plant material increases to the point that the oils resist flow (or are not flowable), or solidify to a degree that the oils no longer easily flow out of the flesh of the plant, such as when the flesh is cut or otherwise broken.

Optionally, a feed conveyor 60 may be configured to move plant material, and may extend from the preprocessing chamber 24 of the enclosure 22 in order to move plant material from the preparation apparatus 20. In some embodiments, the feed conveyor may carry plant materials into, and through, the preprocessing chamber as well as taking the plant materials from the enclosure 24.

The system 1 may include a plant stripping apparatus 70 which is configured to detach constituent parts of the plant material from each other, or otherwise remove the connection between at least some of the constituent parts of the plant material. The plant stripping apparatus 70 may have an input 72 generally configured to receive plant material in a substantially whole condition as the plant vegetated, although some degree of prior processing to the plant may have been performed, such as the initial cooling treatment by the preparation apparatus 20. The stripping apparatus 70 may also have an output 73 from which constituent parts of the plant material are dispensed from the apparatus 70 in a wholly or partially detached condition from each other. The apparatus 70 may be elongated in a longitudinal direction 74 along a longitudinal axis of the apparatus, and may also have a lateral direction which is generally oriented substantially perpendicular to the longitudinal direction 74. The elongated apparatus 70 may have a first end 76 at which the input 72 may be located, and a second end 77 at which the output 73 may be located.

In greater detail, the plant stripping apparatus 70 may include a frame 80 which may be elongated and extend in the longitudinal direction 74 of the stripping apparatus. The frame 80 may have an inboard end located toward the input 72 and the first end 76, and an outboard end located toward the output 73 and the second end 77, of the apparatus.

The plant stripping apparatus 70 may also include a plurality of stripping FIGS. 82, 83 which may include at least one group 84 of the stripping fingers which may be movable with respect to the frame 80 along a path of movement for the fingers. In some embodiments, including the illustrative embodiments, the path of movement follows an endless loop and may include at least one linear portion.

In some embodiments, the plurality of stripping fingers 82, 83 may comprise at least two groups of the stripping fingers, which may include a first group 84 of stripping fingers and a second group 85 of stripping fingers. The stripping fingers of the group or groups of moving stripping fingers may move in a manner which substantially avoids contact between fingers of the groups. For example, the stripping fingers of one h group may have paths of movement which do not overlap or intersect with the paths of movement of another group of stripping fingers, or the positions of the other group of stripping fingers when the stripping fingers of the other group do not move. The groups of fingers may move relative to each other, and the groups of fingers may also move relative to the frame 80, although it is contemplated that some embodiments may have at least one group that does not move with respect to the frame along a path. The stripping fingers of the first group 84 may be oppositely oriented with respect to the fingers of the second group 85, and the fingers of the first and second groups may be oriented substantially parallel to each other. The groups of stripping fingers may move with respect to each other in a first direction which may be oriented substantially parallel to the longitudinal direction 74 of the apparatus, and each group may move relative to the frame in the first direction. In some embodiments, the fingers of the first group 84 may move faster in the first direction relative to the fingers of the second group 85 and relative to the frame 80.

In some embodiments, the stripping fingers may be formed of a material which exhibits a limited degree of resilient bending or flexing capability. Illustratively, the stripping fingers may be formed of a hard or stiff rubber (or other elastomeric) material. Less desirably, the stripping fingers may be formed of a rigid material which substantially prevents flexing or bending of the fingers during usage of the system.

The plant stripping apparatus 70 may further include at least one belt 86 on which at least one of the groups 84. 85 is mounted or formed. A pair of belts 86, 88 may be utilized in some embodiments, with the first group 84 of fingers being mounted on the first belt 86 and the second group 65 of fingers being mounted on the second belt 88. The second belt 88 may be positioned over the first belt 86. Each of the belts 86, 88 may form an endless loop which may be elongated in shape, with one of the long stretches of the loop corresponding to the working surface provided by the respective belt. Suitable supports for the belts 86, 88 may be employed to support the belts on the frame 80, and may comprise, for example, a pair of pulleys for each belt. Also, one or more motors may be employed to move the belts with respect to the frame. In some embodiments, the lower first belt 86 may be extended beyond the extent of the second belt 88 so that the first belt may function as a feed conveyor into the plant stripping apparatus.

The plant processing system 1 may additionally include a plant parts separating apparatus 90 which receives plant material from the output 73 of the plant stripping apparatus 70 to separate constituent parts of the plant material that have been detached from each other by the stripping apparatus 70. Thus, the separating apparatus 90 may be configured to separate the first plant parts of the plant material from the second plant parts which is useful in a processor apparatus in which, for example, some plant parts will receive further processing while other plant parts will not, or some plant parts will receive processing different from other plant parts. The separating apparatus 90 may thus create at least one stream 82 of the constituent parts of the plant material, and in the illustrative embodiment creates a pair of streams 92. 94 of the constituent parts. Illustratively, a first stream 92 includes the first plant parts of the plant material and a second stream 94 includes the second plant parts of the plant material.

An illustrative separating apparatus 90 of the illustrative embodiments may define a plurality of apertures 96 in a surface 98 over which the plant material from the output 13 of the apparatus passes, and the apertures 86 may have sizes and shapes which are configured to allow some plant parts to pass through the apertures while other plant parts are resisted or blocked from passing through the apertures. In the illustrative embodiments, plant parts passing through the apertures form the first stream 92 and plant parts that do not pass through the apertures but continue to pass over the surface 98 of the apparatus 90 form the second stream 94. Illustrative separating apparatus are disclosed in U.S. patent application Ser. No. 16/279,445, filed Feb. 19, 2019 and U.S. patent application Ser. No. 16/559,764, filed Sep. 4, 2019, each of which is hereby incorporated by reference in its entirety.

In embodiments of the system 1, a preparation apparatus 100 may be provided to prepare plant materials for further processing, such as grinding or milling of the plant material to reduce the physical size of the plant material, typically to make further processing of the material easier or more effective, such as oil extraction. The preparation apparatus 100 for a grinding apparatus 102 may be similar in configuration and structure to the preparation apparatus 20. As the parts of the plant (e.g., substantially the whole plant) received by the preparation apparatus 100 for the stripping apparatus 70 may vary from the parts of the plant (e.g., one of the streams of parts from a separating apparatus) being received by the grinding apparatus 102, the configuration of the preparation apparatus 100 may differ somewhat in the manner in which the plant parts are moved into and out of the preparation apparatus 100, and the size and shape of the preprocessing chamber may be different.

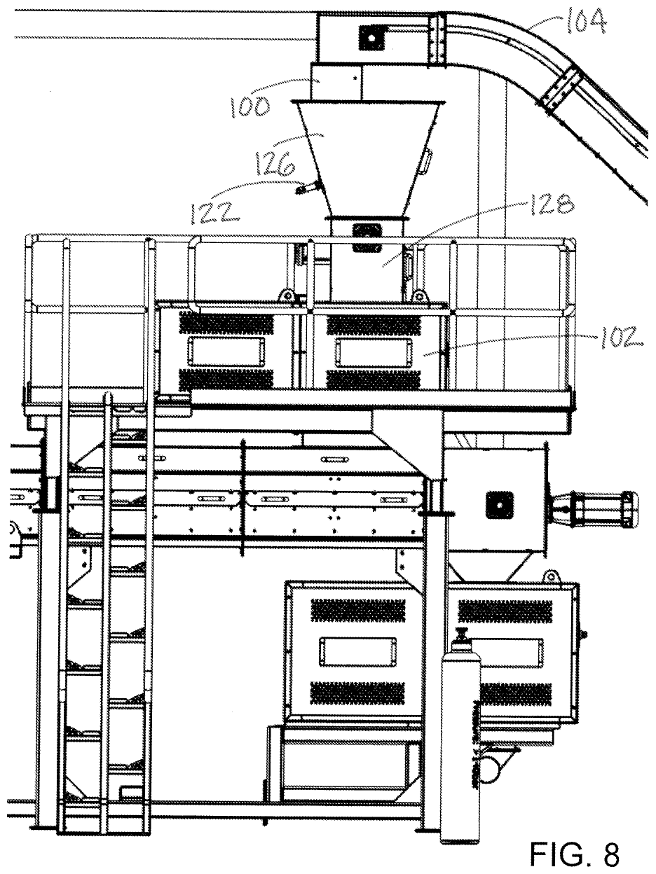

An illustrative embodiment of the system 1 which includes a preparation apparatus 100 and a grinding apparatus 102 is shown in FIGS. 8 through 11. The preparation apparatus 100 may be configured to treat plant materials prior to entering the grinding apparatus 102 to facilitate the grinding action carried out by the apparatus 102 in which the plant material is reduced in size. The preparation apparatus 100 may be mounted on the grinding apparatus 102, and may be located vertically above the grinding apparatus to define a generally vertical flow path for the plant material through the preparation apparatus and the grinding apparatus. The plant material may be brought to the preparation apparatus by a feed conveyor 104 which may have a dispensing portal 106 through which the plant material is dispensed from the feed conveyor to the preparation apparatus.

In greater detail, the preparation apparatus 100 may include a preprocessing enclosure 108 which defines a preprocessing chamber 110 which is configured to receive plant material prior to grinding of the plant material. The preprocessing enclosure 108 may have an entry opening 112 and an exit opening 114, and in some embodiments the entry opening 112 may be positioned at a higher vertical level than the exit opening 114, and illustratively the entry opening may be positioned above the exit opening. The preprocessing enclosure 108 may include a perimeter wall 116 which extends between the entry 112 and exit 114 openings and may function to define the preprocessing chamber.

A gas supply apparatus 118 may be configured to cool the plant material in the preprocessing chamber 110 as the material moves through the chamber 110 and into the grinding apparatus 102. The gas supply apparatus may include one or more of the elements of the gas supply apparatus 40 described herein, and in particular may include at least one nozzle positioned on a spray bar 120 which may extend into the preprocessing chamber 110 for dispensing the cooling fluid into the chamber and onto plant material in the chamber. Optionally, the spray bar may include a plurality of nozzles to more evenly distribute the fluid throughout the chamber. The gas supply apparatus 118 may also include a temperature sensor 122 which may be configured to sense the temperature of the plant material in the preprocessing chamber or plant material having passed through the preprocessing chamber. For example, the temperature sensor 122 may be located beyond the exit opening 112 of the chamber.

A transition structure 124 may define a transition chamber 126 for receiving plant material from the chamber 110 of the preprocessing enclosure 108. The transition chamber may be in communication with the exit opening 114 of the preprocessing enclosure. The temperature sensor 122 may be mounted on the transition structure 124 such that the temperature sensor is able to sense a temperature of the plant material positioned within the transition chamber 126. A feed control structure 128 may be configured to control passage of the plant material out of the transition structure 124 in a controlled manner that is able to adjust the rate at which the plant material moves out of the transition structure and into the grinding apparatus.

The grinding apparatus 102 may be configured to grind plant material received from the preparation apparatus 100. The grinding apparatus 102 may include, for example, at least two grinding rolls 130, 132 which may define a gap therebetween through which the plant material moves and is acted upon by the grinding rolls.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that steps set forth in the description and/or shown in the drawing figures may be altered in a variety of ways. For example, the order of the steps may be rearranged, substeps may be performed in parallel, shown steps may be omitted, or other steps may be included, etc.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A plant processing system for processing plant material, the plant material having at least two different constituent parts, the system comprising:
an initial preparation apparatus for treating plant material prior to processing the plant material, the initial preparation apparatus being configured to lower a temperature of the plant material from an initial temperature to a lowered temperature; and
a plant processing apparatus configured to process the plant material received from the initial preparation apparatus at approximately the lowered temperature.

2. The system of claim 1 wherein the initial preparation apparatus comprises:
a preprocessing enclosure defining a preprocessing chamber configured to receive plant material prior to processing; and
a gas supply apparatus configured to cool plant material in the preprocessing chamber of the preprocessing enclosure.

3. The system of claim 2 wherein the gas supply apparatus comprises:
at least one nozzle at least partially positioned in the preprocessing chamber of the preprocessing enclosure; and
a gas supply tank in communication with the at least one nozzle such that gas in an interior of the gas supply tank is dispensable from the at least one nozzle.

4. The system of claim 3 wherein the gas supply apparatus further comprises:
a temperature sensor configured to sense a temperature in the preprocessing chamber and generate a temperature signal representative of the temperature sensed by the temperature sensor in the preprocessing chamber;
a valve device in communication with the gas supply tank and the at least one nozzle to control the flow of gas from the gas supply tank to the at least one nozzle; and
a controller in communication with the temperature sensor and the valve device to control a condition of the valve device based upon the temperature signal from the temperature sensor and a desired temperature setting for a desired temperature in the preprocessing chamber.

5. The system of claim 1 additionally comprising a feed conveyor configured to move plant material from the initial preparation apparatus to the plant processing apparatus, at least a portion of the feed conveyor being positioned below an exit opening of a preprocessing enclosure of the initial preparation apparatus.

6. The system of claim 1 wherein the plant processing apparatus comprises a plant stripping apparatus configured to detach constituent parts of the plant material from each other.

7. The system of claim 6 wherein the plant stripping apparatus comprises:
a frame extending in a longitudinal direction of the stripping apparatus; and
a plurality of stripping fingers, the plurality of stripping fingers including at least one group of stripping fingers movable with respect to the frame.

8. The system of claim 7 wherein the plurality of stripping fingers includes at least two groups of the stripping fingers, one of the at least two groups being positioned above an other one of the at least two groups.

9. The system of claim 7 wherein the plurality of stripping fingers includes at least two groups of the stripping fingers, a first said group of stripping fingers being movable with respect to a second said group of stripping fingers in a manner such that stripping fingers of the groups substantially avoid contact with each other.

10. The system of claim 7 wherein the at least one group of stripping fingers movable with respect to the frame is mounted on at least one belt.

11. The system of claim 6 additionally comprising a plant part separating apparatus receiving plant material from an output of the plant stripping apparatus, the plant part separating apparatus being configured to separate first plant parts of the constituent parts of the plant material from second plant parts of the constituent parts of the plant material.

12. The system of claim 11 wherein the plant part separating apparatus is configured to create a pair of streams of the constituent parts.

13. The system of claim 1 wherein the plant processing apparatus comprises a plant grinding apparatus configured to grind constituent parts of the plant material.

14. The system of claim 13 wherein the plant grinding apparatus includes a grinding apparatus configured to grind plant material, the grinding apparatus including at least two grinding rolls defining a gap therebetween through which plant material moves.

15. The system of claim 14 wherein the plant grinding apparatus includes a feed control structure configured to control passage of the plant material out of the transition structure.

16. The system of claim 14 wherein the initial preparation apparatus includes a preprocessing enclosure defining a preprocessing chamber configured to receive plant material prior to grinding; and
a gas supply apparatus configured to cool plant material in the preprocessing chamber of the preprocessing enclosure.

17. The system of claim 16 wherein the gas supply apparatus comprising:
at least one nozzle on a spray bar extending into the preprocessing chamber; and
a temperature sensor configured to sense a temperature of the plant material in the preprocessing chamber.

18. The system of claim 1 additionally comprising a mobile base movable on wheels, the initial preparation apparatus and the plant processing apparatus being at least partially supported on the mobile base.

19. The system of claim 18 wherein the mobile base includes at least a pair of wheels mounted on a frame and a hitch extending from the frame to facilitate towing of the mobile base over a road.
